(19) United States
(12) Patent Application Publication
(10) Pub. No.: US 2009/0184908 A1
(43) Pub. Date: Jul. 23, 2009

(54) DISPLAY DRIVING METHOD AND APPARATUS USING THE SAME

(75) Inventors: Cheng-Chi Yen, Tainan County (TW); Hon-Yuan Leo, Tainan County (TW); Yao-Jen Tsai, Nantou County (TW)

Correspondence Address: J C PATENTS, INC., 4 VENTURE, SUITE 250, IRVINE, CA, 92618, US

(73) Assignee: HIMAX DISPLAY, INC., Tainan County (TW)

(21) Appl. No.: 12/133,624

(22) Filed: Jun. 5, 2008

(30) Foreign Application Priority Data
Jan. 17, 2008 (TW) 97101798

(51) Int. Cl. G09G 3/36

(52) U.S. Cl. 345/87

(57) ABSTRACT

The present invention discloses a display driving method and apparatus using the same. The driving method of driving a display panel having pixel cells formed at each intersection of a plurality of scan lines and a plurality of data lines, said method comprising: simultaneously driving the pixel cells corresponding to the nth to (n+m)th scan lines according to a plurality of first pixel signals corresponding to the nth scan line; and simultaneously driving the pixel cells corresponding to the (n+1)th to (n+m+1)th scan lines according to a plurality of second pixel signals corresponding to the (n+1)th scan line wherein n is a positive integer and m is a positive integer.

### CROSS-REFERENCE TO RELATED APPLICATION

This application claims the priority benefit of Taiwan application serial no. 97101798, filed on Jan. 17, 2008. The entirety the above-mentioned patent application is hereby incorporated by reference herein and made a part of specification.

### BACKGROUND OF THE INVENTION

1. Field of Invention

The present invention relates to a driving method and apparatus using the same, and more particularly to a display driving method and apparatus using the same.

2. Description of Related Art

Generally speaking, a liquid crystal display panel has a plurality of pixel cells. Scan lines and data lines combine to control the pixel cells to display images. In order to achieve better display quality, a resolution is enhanced, and then the pixel cells are being increased more and more. A 17-inch LCD panel with a high resolution of 1280*1024 has more than 130 thousand pixel cells. Thus, the pixel cells are adjacently being crowded. Therefore, the capacitances of adjacent pixel cells affect each other and then the display quality of the panel is reduced.

A liquid crystal display, such as a LCoS (Liquid Crystal on Silicon) panel comprises a plurality of pixel cells, Each pixel cell of the panel has a capacitor to store a pixel signal. The gray level displayed by the pixel cell is determined by the magnitude of pixel signal in the capacitor, regardless of the polarity of the pixel signal. For avoiding deterioration of the liquid crystal, an AC driving method is used for driving the liquid crystal of the panel. The frame inversion is a kind of AC driving method which stores pixel signals of two adjacent frames with different polarities. While this method stores positive pixel signals for a previous frame, it stores negative pixel signals for the present frame. As a result of the frame inversion, the pixel signals stored in the capacitances of the adjacent pixel cells couple to each other while updating new ones that have different polarities. For this reason, the capacitances store inappropriate pixel signals to induce distortion of the gray levels and the display quality is reduced.

FIG. 1 illustrates a circuit diagram of pixel cells of a LCoS display panel. The panel comprises data lines D11, D12, scan lines S11, S12, and pixel cells. The pixel cells comprises transistors T11-T14 and storage capacitances C11˜C14. The scan line S11 is electrically connected to gates of the transistors T11, T12 and controls the transistors T11, T12 by a scan signal. The data lines D11 and D12 respectively transmit two pixel signals to the capacitors C11, C12 through the transistors T11, T12 while the transistors T11, T12 are turned on by the scan signal.

After the capacitors C11, C12 store the pixel signals individually, the scan line S11 is unasserted and scan line S12 is asserted, such that the transistors T11, T12 are turned off and the transistors T13, T14 are turned on. However, the couple effect occurs between the capacitances C13, C14 and the capacitances C11, C12 such that the pixel signals stored in the capacitor C11, C12 are distorted by the capacitances C13, C14.

FIG. 2A illustrates a timing diagram of scan signals of a display panel. FIG. 2B illustrates a pixel distribution diagram of the display panel which receives scan signals as shown in FIG. 2A. Referring to FIG. 2A and FIG. 2B, at time T22, scan line S12 is asserted such that the positive pixel signals for the pixel cells of scan line S12 are transmitted to the pixel cells of the scan lines S12. While scan line S12 is unasserted, the contents of the pixel cells of the scan line S12 are affected by the pixel cells of the scan line S13 via coupling effect since they are of the different polarity. The above method is to drive the scan lines one by one sequentially. The pixel cells of the present active scan line will affect the pixel cells of the previous active scan line. Then, the data stored in the pixel cells of the previous active scan line will be distorted. Therefore, the display quality is seriously reduced.

### SUMMARY OF THE INVENTION

The present invention is to provide a driving method of driving a display panel having pixel cells formed at each intersection of a plurality of scan lines and a plurality of data lines, in which the interference between adjacent scan lines is eliminated and display quality is also promoted.

Furthermore, the present invention is to provide a display apparatus, which eliminates couple effect of storage capacitances of scan lines and promotes display quality.

Moreover, the present invention is to provide a driving method of a gate driver having a plurality of channels, which eliminates interference between scan lines and promotes display quality.

The present invention provides a driving method of driving a display panel having pixel cells. The pixel cells are formed at each intersection of a plurality of scan lines and a plurality of data lines. The method comprises: First, the pixel cells are driven corresponding to the nth to (n+m)th scan lines simultaneously. A plurality of first pixel signals corresponding to the nth scan line are transmitted to the pixel cells from nth to (n+m)th scan lines. Next, the pixel cells are driven corresponding to the (n+1)th to (n+m+1)th scan lines simultaneously. A plurality of second pixel signals the (n+1)th scan line are transmitted to the pixel cells from nth to (n+m)th scan lines. Specifically, n is a positive integer and m is a positive integer.

The present invention further provides a display apparatus comprising a display panel, a gate driver and a source driver. The display panel has pixel cells formed at each intersection of a plurality of scan lines and a plurality of data lines. The gate driver is coupled to the plurality of scan lines. The source driver is coupled to said plurality of data lines. During a first time, the gate driver simultaneously switches on the nth to (n+m)th scan lines and the source driver drives the pixel cells corresponding to the nth to (n+m)th scan lines according to a plurality of first pixel signals corresponding to the nth scan line. During a second time, the gate driver simultaneously switches on the (n+1)th to (n+m+1)th scan lines and the source driver drives the pixel cells corresponding to the (n+1)th to (n+m+1)th scan lines according to a plurality of second pixel signals corresponding to the (n+1)th scan line; wherein n is a positive integer and m is a positive integer.

The present invention further provides a driving method of a gate driver. The gate driver has a plurality of channels. Each of the channels is coupled to a scan line. The method comprises the step of: In a first scanning time interval, the plurality of channels from nth to (n+m)th channel are turned on simultaneously corresponding to nth scan line. In a second time interval, the plurality of channels from (n+1)th to (n+m+1)th channel are turned on simultaneously corresponding to (n+1)th scan line. Specifically, n is a positive integer and m is a positive integer.

In the present invention, as driving at least two scan lines at the same time, couple effect of storage capacitances of scan lines is eliminated and display quality is promoted.

In order to make the aforementioned and other features and advantages of the present invention comprehensible, preferred embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates a circuit diagram of pixel cells of a display panel.

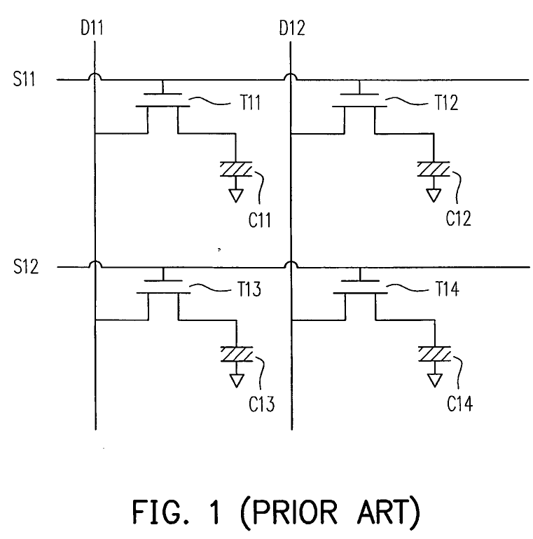

FIG. 2A illustrates a timing diagram of scan signals of a display panel.

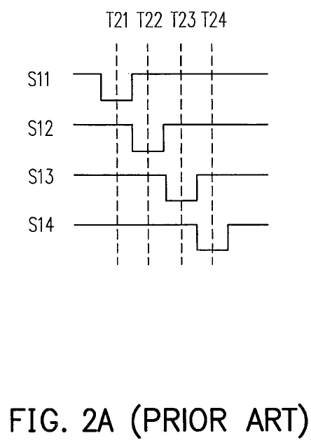

FIG. 2B illustrates a frame driven by the scan signals as shown in FIG. 2A.

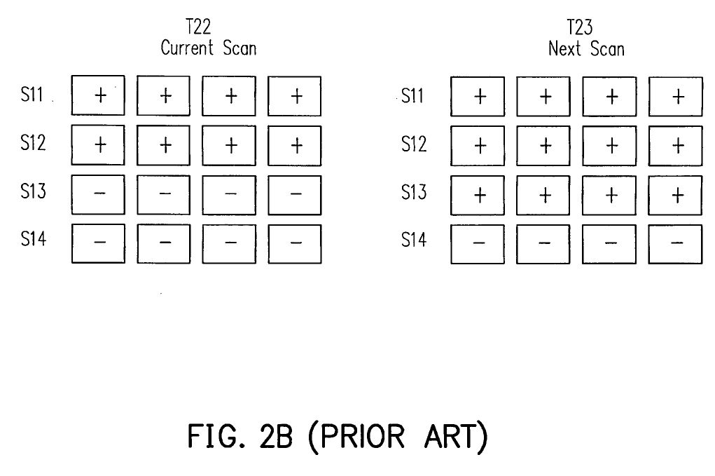

FIG. 3A illustrates a timing diagram of scan signals of a display panel according to an embodiment of the present invention.

FIG. 3B illustrates a frame driven by the scan signals as shown in FIG. 3A.

FIG. 4 illustrates a frame inversion type of a display panel according to another embodiment of the present invention.

FIG. 5A illustrates a timing diagram of scan signals of a delta-type display panel according to an embodiment of the present invention.

FIG. 5B illustrates a frame driven by the scan signals as shown in FIG. 5A.

FIG. 6 illustrates a driving method of driving a display panel having pixel cells according to an embodiment of the present invention.

### DESCRIPTION OF EMBODIMENTS

The present invention will now be described with reference to the accompanying drawings, in which exemplary embodiments of the invention are shown. The invention may, however, be embodied in many different forms and should not be construed as being limited to the embodiments set forth herein. Furthermore, the embodiments are provided so that this disclosure will be thorough and complete, and will fully convey the concept of the invention to those skilled in the art. LCoS (Liquid Crystal on Silicon) is taken as an example in the embodiments to illustrate the operating principle of the present invention. However, the embodiments of the present invention are not limited to the LCoS. Any display in this field is also suitable to be used in the present invention, such as LCD (Liquid Crystal Display) and OLED (Organic Light-Emitting Diode) display.

In the drawings, whenever the same element reappears in subsequent drawings, it is denoted by the same reference numeral.

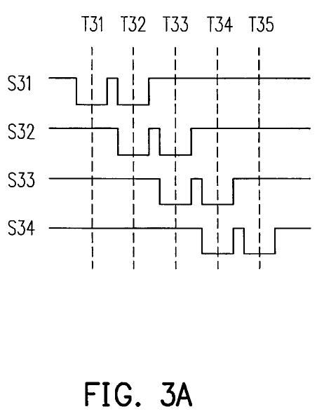

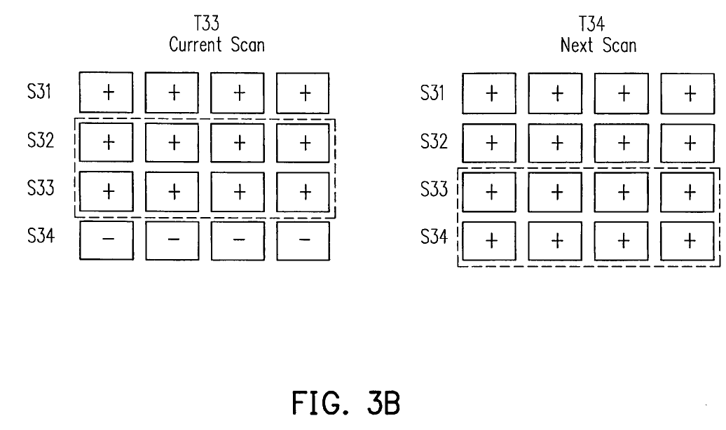

FIG. 3A illustrates a timing diagram of scan signals of a display panel according to an embodiment of the present invention. FIG. 3B illustrates a frame driven by the scan signals as shown in FIG. 3A. The display panel has pixel cells formed at each intersection of a plurality of scan lines and a plurality of data lines. A gate driver (not shown) includes a plurality of channels for generating a plurality of scan signals to the plurality of scan lines. A source driver (not shown) generates a plurality of pixel signals for driving the data lines. The display panel operates by frame inversion method, which changes polarities of pixel cells while storing pixel signals frame by frame.

At first, the previous frame is negative. At time T33, both scan lines S32 and S33 are asserted such that the positive pixel signals for the pixel cells of scan line S32 are transmitted to the pixel cells of the scan lines S32 and S33 both. Thus, the contents and polarities of the pixel cells of the scan lines S32 and S33 are the same. While scan line S32 is unasserted, the contents of the pixel cells of the scan line S32 are less affected by the pixel cells of the scan line S33 via coupling effect since they are of the same polarity.

At time T34, both scan lines S33 and S34 are asserted such that the positive pixel signals for the pixel cells of scan line S33 are transmitted to the pixel cells of the scan lines S33 and S34 both. Thus, the contents and polarities of the pixel cells of the scan lines S33 and S34 are the same. While scan line S33 is unasserted, the contents of the pixel cells of the scan line S33 are less affected by the pixel cells of the scan line S34 via coupling effect since they are of the same polarity.

The display panel of the above embodiment asserts two scan lines simultaneously to avoid coupling effect. Those skilled in the art should understand that the number of simultaneously asserted scan lines can be multiple more than two.

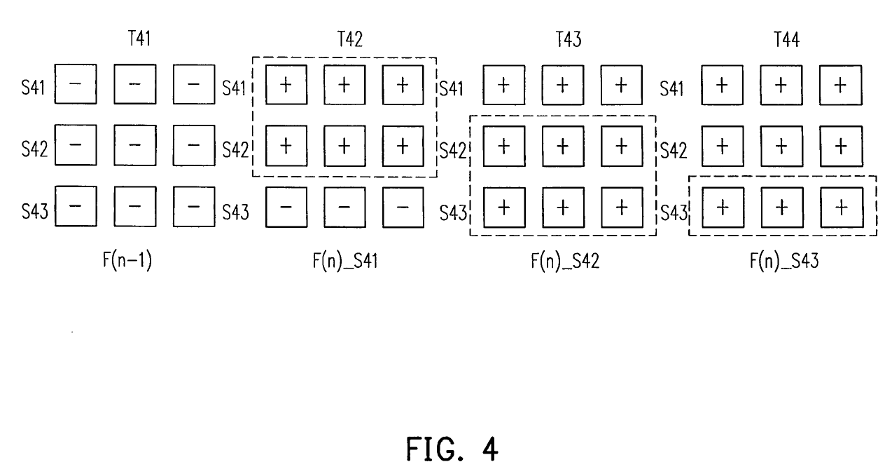

FIG. 4 illustrates a frame inversion type of a display panel according to another embodiment of the present invention. At time T41, the previous frame F(n−1) is negative. Due to frame inversion, the pixel cells of scan lines would change their polarities from negative to positive in turn when receive the pixel signals corresponding to the next frame. At time T42 of frame F(n)_S41, both scan lines S41 and S42 are asserted such that the positive pixel signals for the pixel cells of scan line S41 are transmitted to the pixel cells of the scan lines S41 and S42 both. Thus, the contents and polarities of the pixel cells of the scan lines S41 and S42 are the same. At time T43 of frame F(n)_S42, both scan lines S42 and S43 are asserted such that the positive pixel signals for the pixel cells of scan line S42 are transmitted to the pixel cells of the scan lines S42 and S43 both. Thus, the contents and polarities of the pixel cells of the scan lines S42 and S43 are the same. At time T44 of frame F(n)_S43, the scan line S43 is asserted such that the pixel signals for the scan line S43 are transmitted to the pixel cells of the scan line S43. Then, the present frame F(n), comprising F(n)_S41˜F(n)_S43, is positive and completely finished. Therefore, since the polarities of the pixel cells of scan line S42 have set to positive at time T42 beforehand, the pixel signals stored on the pixel cells of scan line S41 are not distorted while the pixel cells of scan line S42 receiving related pixel signals at time T43. Similarly, at time T44, the pixel signals stored on the pixel cells of scan line S42 are not distorted while the pixel cells of scan line S43 receiving related pixel signals.

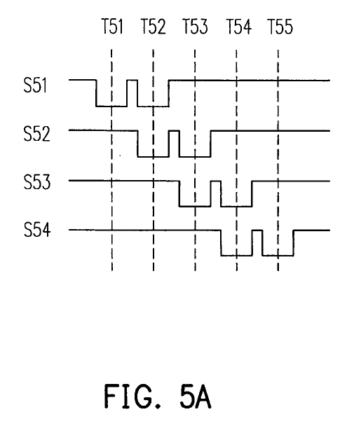

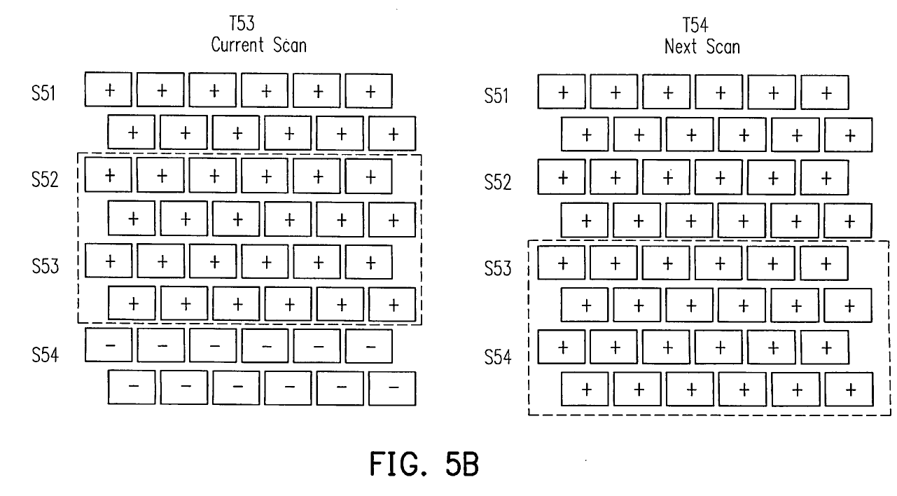

FIG. 5A illustrates a timing diagram of scan signals of a delta-type display panel according to another embodiment of the present invention. FIG. 5B illustrates a frame driven by the scan signals shown in FIG. 5A. Each of scan lines S51-S54 drives two arrays of pixel cells of the delta-type display panel.

Referring to FIG. 5A and FIG. 5B, scan signals are asserted to enable scan lines S51-S54. At time T53, both scan lines S52 and S53 are asserted such that the positive pixel signals for the pixel cells of scan line S52 are transmitted to the pixel cells of the scan lines S52 and S53 both. Thus, the contents and polarities of the pixel cells of the scan lines S52 and S53 are the same. While scan line S52 is unasserted, the contents of the pixel cells of the scan line 52 are less affected by the pixel cells of the scan line S53 via coupling effect since they are of the same polarity.

Next, at time T54, both scan lines S53 and S54 are asserted such that the positive pixel signals for the pixel cells of scan line S53 are transmitted to the pixel cells of the scan lines S53 and S54 both. Thus, the contents and polarities of the pixel cells of the scan lines S53 and S54 are the same. While scan line S53 is unasserted, the contents of the pixel cells of the scan line S53 are less affected by the pixel cells of the scan line S54 via coupling effect since they are of the same polarity. Therefore, the pixel signals stored on the pixel cells of scan line S53 are not distorted by the pixel cells of scan line S54 while receiving pixel signals.

According to above embodiments, those skilled in the art should understand that the display panel is not limited to operate by frame inversion, but also column inversion or dot inversion. As long as any two adjacent pixel cells need to alternate change their polarities, the present invention is also suitable to be used.

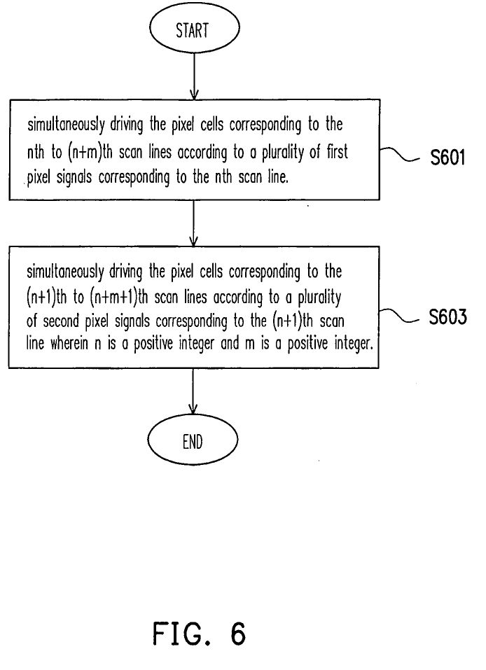

FIG. 6 illustrates a driving method of driving a display panel having pixel cells according to an embodiment of the present invention. The driving method of driving a display panel having pixel cells formed at each intersection of a plurality of scan lines and a plurality of data lines comprises following steps. First, in step S601, the pixel cells are driven corresponding to the nth to (n+m)th scan lines simultaneously. A plurality of first pixel signals corresponding to the nth scan line are transmitted to the pixel cells from nth to (n+m)th scan lines. Next, in step S603, the pixel cells are driven corresponding to the (n+1)th to (n+m+1)th scan lines simultaneously. A plurality of second pixel signals corresponding to the (n+1)th scan line are transmitted to the pixel cells from nth to (n+m)th scan lines. Specifically, n is a positive integer and m is a positive integer.

To sum up, as driving at least two scan lines at the same time, couple effect of storage capacitances of scan lines is eliminated and display quality is promoted.

Though the present invention has been disclosed above by the preferred embodiments, they are not intended to limit the invention. Anybody skilled in the art can make some modifications and variations without departing from the spirit and scope of the invention. Therefore, the protecting range of the invention falls in the appended claims.

What is claimed is:

1. A driving method of driving a display panel having pixel cells formed at each intersection of a plurality of scan lines and a plurality of data lines, said method comprising:
simultaneously driving the pixel cells corresponding to the nth to (n+m)th scan lines according to a plurality of first pixel signals corresponding to the nth scan line; and
simultaneously driving the pixel cells corresponding to the (n+1)th to (n+m+1)th scan lines according to a plurality of second pixel signals corresponding to the (n+1)th scan line wherein n is a positive integer and m is a positive integer.

2. The driving method claimed in claim 1, wherein the display panel is a frame inversion display panel.

3. A display apparatus comprising:
a display panel, having pixel cells formed at each intersection of a plurality of scan lines and a plurality of data lines;
a gate driver, coupled to said plurality of scan lines; and
a source driver, coupled to said plurality of data lines;
wherein, during a first time, said gate driver simultaneously switching on the nth to (n+m)th scan lines and said source driver driving the pixel cells corresponding to the nth to (n+m)th scan lines according to a plurality of first pixel signals corresponding to the nth scan line; and
during a second time, said gate driver simultaneously switching on the (n+1)th to (n+m+1)th scan lines and said source driver driving the pixel cells corresponding to the (n+1)th to (n+m+1)th scan lines according to a plurality of second pixel signals corresponding to the (n+1)th scan line;
wherein n is a positive integer and m is a positive integer.

4. A driving method of a gate driver having a plurality of channels, each of the channels coupled to a scan line, said method comprising the step of:
simultaneously turning on the plurality of channels from nth to (n+m)th channel in a first scanning time interval corresponding to nth scan line; and
simultaneously turning on the plurality of channels from (n+1)th to (n+m+1)th channel in a second time interval corresponding to (n+1)th scan line wherein n is a positive integer and m is a positive integer.
